(19) United States
(12) Patent Application Publication
(10) Pub. No.: US 2002/0133439 A1
(43) Pub. Date: Sep. 19, 2002

(54) Method and account management system for charging for services provided in a telecommunications network

(76) Inventors: Manfred Lilge, Berlin (DE); Thomas Ryll, Berlin (DE)

Correspondence Address: BELL, BOYD & LLOYD, LLC, P. O. BOX 1135, CHICAGO, IL, 60690-1135, US

(21) Appl. No.: 10/079,459

(22) Filed: Feb. 20, 2002

(30) Foreign Application Priority Data
Feb. 20, 2001 (DE) 101 09 908.8

(51) Int. Cl. G06F 17/60

(52) U.S. Cl. 705/35

(57) ABSTRACT

An account management system for charging for services provided in a telecommunications network, which has at least one first account class and a second account class for a service receiver (consumer), where the accounts in the first account class can be filled upon payment of a fixable rate of value added tax, and the accounts in the second account class can be filled without payment of a rate of value added tax. The inventive method for charging for services provided in a telecommunications network is carried out using an account management system having at least one first account class and a second account class for the service receiver (consumer), where a rate of value added tax is not paid when charging via an account in the first account class, and a fixable rate of value added tax is paid when charging via an account in the second account class.

### BACKGROUND OF THE INVENTION

Telecommunications networks are today used not only for the function of purely setting up connections between two or more telecommunication lines (i.e., pure telephony), but also increasingly for providing and selling other services or products. In principle, at least three different roles can be distinguished in a purchase transaction within a telecommunications network. First, it involves a supplier of a service or a product, who is also referred to as the merchant. The merchant demands appropriate remuneration for a service which he/she provides or for a product which he/she supplies. Secondly, there is a purchaser of a service provided by the merchant or of a product supplied by the latter. This “consumer” has to pay the appropriate remuneration for the service received. Finally, there also must be a unit which handles the payments between a merchant and a consumer; this is a “payment service provider” (PSP).

In the conventional world of telecommunications, a network operator for a telecommunications network usually takes on the role both of PSP and of merchant. It provides its customers, the “consumers”, with telephone services and uses its charging systems or “billing systems” which have been set up for charging in advance (“prepaid”), or at a later time (“postpaid”). In this context, “prepaid” accounts can be filled by the consumer in various ways. Only if the account has been filled is the consumer able to use services over the telecommunications network. Currently, the most common way of filling such a “prepaid” account is to fill it using “vouchers”. These vouchers can be obtained for a particular amount at specialist outlets. They are provided with a particular identification number. When this identification number is entered by the consumer, this automatically fills his/her “prepaid” account.

These “prepaid” accounts differ from normal bank accounts or credit card accounts in that, among other things, a rate of value added tax (VAT) is paid to the state. As such, value added tax is paid when a consumer actually purchases a voucher.

If a consumer's bank account is debited when making a purchase, the merchant pays the appropriate rate of value added tax on his/her sales after the purchase transaction. With a “prepaid” account, on the other hand, the network operator pays the appropriate rate of value added tax when the voucher is sold, and then does not charge the value added tax component individually when providing its telecommunications service.

An object of the present invention, therefore, is to provide a simple method and an appropriate account management system which allow the two alternatives for paying value added tax (i.e., sometimes before and sometimes after the service has been provided by a merchant), to be combined with one another such that both alternatives are available for selection on a case by case basis.

### SUMMARY OF THE INVENTION

In an embodiment, the present invention provides a method for charging for services provided in a telecommunications network using an account management system having at least one first account class and a second account class for the service receiver (consumer), where a rate of value added tax is not paid when charging via an account in the first account class, and a fixable rate of value added tax is paid when charging via an account in the second account class.

The inventive method solves a problem, arising again and again in m-commerce, which arises when a consumer wishes to use his/her “prepaid” account to use services from merchants other than the network operator. This is because the rate of value added tax would be paid twice in this case. If the “prepaid” account of a consumer is debited when buying a CD, for example, the merchant would have to pay an appropriate rate of value added tax when providing the service; i.e., in this case upon successful delivery of the CD. However, this would mean that the sum of money coming from the “prepaid” account would have a value added tax charged on it once again, this time by the merchant, even though an appropriate rate of value added tax already has been paid to the network operator when a voucher filling the account was purchased.

The inventive method now makes it possible, depending on the service, in particular depending on the origin of the service (i.e., which merchant provides the service), to charge for this service via an account in the first account class or via an account in the second account class.

In one preferred embodiment of the inventive method, a fixable rate of value added tax is paid when filling an account in the first account class; in this case, an account in the first account class is preferably filled using a voucher. This makes it possible to charge for all services provided by the network operator via an account in the first account class. In this case, the appropriate rate of value added tax to be paid is then paid only once; namely, directly upon filling or when an appropriate voucher is purchased.

Services provided by a merchant other than the network operator now can be charged for, preferably automatically, via an account in the second account class. As such, the value added tax is charged and paid once only when the service is provided. This prevents the consumer from being charged twice through double payment of value added tax. An account in the second account class therefore can be used for any m-commerce scenarios; in particular, for shopping scenarios with a third party as the merchant. In this case, the merchant is obliged to use the correct rate of value added tax fixed for his/her provided service. Thus, generally, in Germany, 16% value added tax is charged for a service or for a product, but just 7% for book sales, for example.

In another preferred embodiment of the method of the present invention, an account in the second account class is filled using a regular debit procedure.

Preferably, the account management system is run by a payment service provider (PSP). In this case, the payment service provider is preferably the network operator of the telecommunications network at the same time. As such, the network operator at the same time also has an overview of, by way of example, how many consumers use services from other merchants, and how often.

In addition, the present invention provides an account management system for charging for services provided in a telecommunications network, where the account management system has at least one first account class and a second account class for a service receiver (consumer), and accounts in the first account class can be filled upon payment of a fixable rate of value added tax, and accounts in the second account class can be filled without payment of a rate of value added tax.

In this context, an account in the first account class preferably can be filled using a voucher. This practice of filling a “prepaid” account has been found to be very quick and uncomplicated as far as charges for services from the network operator itself were involved. In the first account class, a number of different accounts can be set up for the consumer and can be used for charging for various services. Thus, by way of example, a separate account can be set up for pure telephony, and another one can be set up for SMS, for example. This simultaneously provides the network operator with a certain degree of “bookkeeping” relating to the type and frequency of the services it provides which are used.

In another preferred embodiment of the inventive account management system, an account or all accounts in the second account class can be filled using a debit procedure.

In addition, the present invention provides an account administration system which has an inventive account management system and at least one account for a service provider (merchant). The account administration system is preferably operated by a payment service provider (PSP).

The present invention also provides for the use of an inventive account management system and/or an inventive account administration system for charging for services provided in a telecommunications network, particularly in the field of m-commerce, which is becoming more and more widespread.

Additional features and advantages of the present invention are described in, and will be apparent from, the following Detailed Description of the Invention and the Figures.

### BRIEF DESCRIPTION OF THE FIGURES

FIG. 1 shows an exemplary illustration of an embodiment of an inventive account management system.

### DETAILED DESCRIPTION OF THE INVENTION

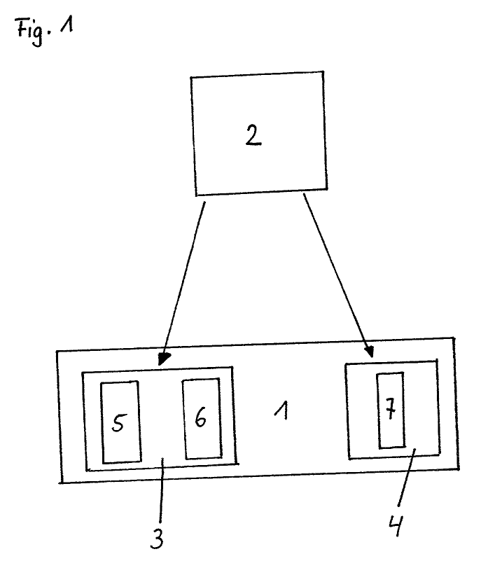

FIG. 1 shows an exemplary configuration of an inventive account management system l for charging for services provided in a telecommunications network. The inventive account management system 1 is a real-time account management system (“payment system”). Preferably, it is incorporated into an account administration system which also administers accounts for one or more merchants. Preferably, the account administration system and, hence, the account management system 1 are operated by a payment service provider (PSP). In the example shown here, the account management system 1 for the consumer 2 includes two account classes, a first account class 3 and a second account class 4. The first account class 3, in turn, includes two accounts 5 and 6. In this case, the accounts 5 and 6 already have been filled, such as by using a voucher, and an appropriate rate of value added tax has been paid. The appropriate rate of value added tax is actually deducted by the network operator when the voucher is purchased. Accordingly, the accounts 5 and 6 in the first account class 3 are accounts for which value added tax already has been paid. In this case, the second account class 4 includes just one account 7. The account 7 is an account for which no value added tax already has been paid. Such an account 7 can be filled, by way of example, using a regular debit procedure. In the present case, the network operator provides the consumer 2 with two accounts 5 and 6 in the first account class 3; namely, an account 5 for pure telephony and an account 6 for SMS. Both are services which are provided directly by the network operator itself. It is, therefore, practical and effective in this case to pay the value added tax incurred for these services as a lump sum in advance, instead of having to pay it separately for each individual one of these services every time. When a voucher is purchased for filling these accounts 5 and 6, the network operator charges the consumer as much as 16% value added tax. In this case, the second class 4 contains an account 7 for m-commerce, for full electronic handling of a payment transaction in the mobile environment, for which the network operator pays no value added tax. An appropriate rate of value added tax is charged and paid by the PSP or the merchant only when a service is provided. When a CD is purchased, for example, an appropriate rate of value added tax is paid only upon successful delivery of the CD. In this case, the merchant is obliged to use the rate of value added tax which applies to the service. Thus, normally, in Germany, 16% value added tax is charged for a service or a product, but just 7% value added tax for book sales.

Although the present invention has been described with reference to specific embodiments, those of skill in the art will recognize that changes may be made thereto without departing from the spirit and scope of the invention as set forth in the hereafter appended claims.

1. A method for charging for services provided in a telecommunications network using an account management system having at least one first account class and a second account class for a service receiver, the method comprising the steps of:
not paying a rate of value added tax when charging via an account in the first account class; and
paying a fixable rate of value added tax when charging via an account in the second account class.

2. A method for charging for services provided in a telecommunications network as claimed in claim 1, the method further comprising the step of paying a fixable rate of value added tax when filling an account in the first account class.

3. A method for charging for services provided in a telecommunications network as claimed in claim 1, the method further comprising the step of filling an account in the first account class using a voucher.

4. A method for charging for services provided in a telecommunications network as claimed in claim 1, the method further comprising the step of filling an account in the second account class using a debit procedure.

5. A method for charging for services provided in a telecommunications network as claimed in claim 1, the method further comprising the step of running the account management system by a payment service provider.

6. A method for charging for services provided in a telecommunications network as claimed in claim 5, wherein th e payment service provider is a network operator of the telecommunications network .

7. An account management system for charging for services provided in a telecommunications network, comprising:
at least one first account class for a service receiver; and
a second account class for a service receiver;
wherein the first account class may be filled upon payment of a fixable rate of value added tax, and accounts in the second account class may be filled without payment of a rate of value added tax.

8. An account management system for charging for services provided in a telecommunications network as claimed in claim 7, wherein an account in the first account class may be filled using a voucher.

9. The account management system for charging for services provided in a telecommunications network as claimed in claim 7, wherein an account in the second account class may be filled using a debit procedure.

10. An account management system for charging for services provided in a telecommunications network as claimed in claim 7, wherein the account management system is used in an account administration system which further includes at least one account for a service provider.
